(19) United States
(12) Patent Application Publication
(10) Pub. No.: US 2021/0394665 A1
(43) Pub. Date: Dec. 23, 2021

(54) SPACE-EXPANDABLE AND EASILY TRANSPORTABLE CARAVAN

(71) Applicant: Dic Co., Ltd., Chungcheongnam-do (KR)

(72) Inventor: Won Seok Oh, Yongin-si, Gyeonggi-do (KR)

(73) Assignee: Dic Co., Ltd., Chungcheongnam-do (KR)

(21) Appl. No.: 17/287,872

(22) PCT Filed: Oct. 22, 2019
(86) PCT No.: PCT/KR2019/013874

§ 371 Date: Apr. 22, 2021

(30) Foreign Application Priority Data
Nov. 7, 2018 (KR) 10-2018-0135663

(51) Int. Cl. B60P 3/34; B60P 3/39

(52) U.S. Cl. CPC B60P 3/34; B60P 3/39

(57) ABSTRACT

The space-expandable and easily transportable caravan according to present invention is a cubical caravan, wherein the caravan has a structure in which both sides expand symmetrically, characterized by: comprising a caravan (100) which has a cubical upper main body (110) having space expandable and collapsible panel unit and a lower main body carrier (120) integrally attached thereunder to support the upper main body (110); the space expandable and collapsible panel unit is expandable from sides comprising external panels (10a, 10b) and internal panels (20a, 20b) on each of side walls of the caravan, wherein each external panel (10a, 10b) comprises roof panel (11a, 11b) which forms an expansion roof by spreading it outwards, and expansion external panel (12a, 12b) which forms an expanded side outer wall, and each of the internal panel (20a, 20b) comprises floor panel (21a, 21b) which forms an expansion floor by spreading it downwards, and expansion side panel (22a and 23a, 22b and 23b) which forms the front and back expanded outer wall. The space-expandable caravan (100) of present invention can be set up by conveniently loading onto a cargo box of a truck by lifting the caravan using four jacks, and easily unloading from the cargo box to a desired place.

### TECHNICAL FIELD

The present invention relates to a caravan. More specifically, the present invention is directed to a caravan that is convenient to transport and is space-expandable.

### BACKGROUND ART

Camping cars correspond to a special class of vehicles that are designed to allow a person to travel in the vehicle at any place and camp therein in a pleasant environment by using various living facilities and amenities installed within the vehicle. The size of camping cars can be varied from small pickup trucks to buses.

Caravans correspond to an enclosure equipped with various living facilities inside and supported on a wheeled platform or trailer which can be moved when it is towed by a car. Compared to caravans, camping cars that can move by themselves are also known as motor caravans.

Presently, traveling or camping with the camping car or the caravan is gaining appeal and popularity among people who want to enjoy traveling and leisure activities out in nature. To meet such wants and demands, diverse types of camping cars, or caravans, have been developed and used.

Korean Utility Model Registration No. 20-0336166 discloses a camping car equipped with house expander in order to allow the user to expand interior space as one likes.

Korean Utility Model Registration No. 20-0402023 discloses a camping car that allows the user to utilize spacious interior space by expanding it in one or both directions.

Korean Patent Registration No. 10-0983626 discloses a camping car that expands interior space by extending a side-panel outwards, wherein the side-panel is equipped on the left or right side of the camping car.

Korean Patent Registration No. 10-1381001 discloses a caravan that can expand interior space by moving the ceiling and a side auxiliary box upwards and sideways respectively, and improves convenience of manipulation while minimizing number of actuators by having interconnected movement of the side auxiliary box and the ceiling.

U.S. Pat. No. 9,597,993 B2 discloses an expandable habitation vehicle.

However, the existing camping cars or caravans are unable solve the fundamental problem of difficulty in transporting and small confined spaces.

Firstly, the camping car which is basically a vehicle equipped with various living facilities cannot be utilized as a vehicle separated from the living facilities. Thus there is a burden of travelling with all the living facilities all the time. If the camping is sparsely done annually, the vehicle of the camping car will be parked in a garage for most of the time, and in this case it is not economical considering the low cost effectiveness. Further, the camping cars are very confining because of limited interior space. There are large camping cars such as camping buses, but the disadvantages are high cost and requirement of acquiring appropriate driving license to drive such camping buses.

Whereas, a caravan supported on a wheeled platform or trailer is towed by another vehicle, and since it can be separated from the vehicle it has an advantage that the vehicle can be used when the caravan is not in use. However, in order to tow a caravan with a vehicle, a separate towing license is required. Also, even with the towing license, it is difficult to tow a caravan in places with poor road conditions.

Camping cars and caravans thus have a fundamental problem of having confined spaces. On average, camping cars and caravans have an area of about 4˜7 m². The minimum living space in which a person would not feel uncomfortable or stifling is known to be about 10 m², but living spaces of existing camping cars or caravans are not as large as 10 m². In order to expand the living spaces of camping cars or caravans they should be bus-sized, which is very impractical in terms of cost of the vehicle, storage and maintenance, and driving.

Thus there has been a need for an improvement in the caravan design to address the fundamental problem of having confined spaces in the existing camping cars and caravans which can provide the living space of atleast 10 m² but still can be easily transported by one-ton pickup truck regardless of road conditions, can be transported by a towing vehicle by loading the caravan onto a trailer, can be towed by a passenger car by keeping the entire weight under 750 kg, and can be easily transported and expanded by anyone, to solve all the problems existing camping cars or caravans have.

### DISCLOSURE OF INVENTION

### Technical Problem

The purpose of the present invention is to provide a novel space-expandable caravan that can expand a small living space of a caravan from approximately 4 m² up to about three-fold, 12 m².

Other purpose of the present invention is to provide a space-expandable caravan that can be expanded up to about 12 m² so that camping experience is pleasant and neither stifling nor uncomfortable.

Another purpose of the present invention is to provide a space-expandable caravan that can be towed by a towing vehicle by loading the caravan onto a trailer.

Further purpose of the present invention is to provide a space-expandable caravan that can be towed by a passenger car after loading the caravan onto a trailer by keeping the entire weight of the caravan under 750 kg.

Further purpose of the present invention is to provide a space-expandable caravan that can be loaded on pickup truck for easy transportation regardless of road conditions.

Further purpose of the present invention is to provide a space-expandable caravan that can be easily expanded, disassembled and assembled by anyone.

The aforementioned and other purposes of present invention can be achieved by the present invention described in more detail below.

### Solution to Problem

The space-expandable and easily transportable caravan according to present invention is a cubical caravan having space expandable and collapsible panel unit and housing various living facilities, wherein the space expandable and collapsible panel unit is symmetrically expandable from both sides.

In a preferred embodiment the present caravan (100) comprises a cubical upper main body (110) having the space expandable and collapsible panel unit and housing the various living facilities and a lower main body carrier (120) integrally attached thereunder to support the upper main body (110); the space expandable and collapsible panel unit comprises external panels (10a, 10b) and internal panels (20a, 20b) on each of side walls of the caravan (100), wherein each of said external panels (10a, 10b) comprises roof panel (11a, 11b) which forms an expansion roof upon outward unfolding, and expansion external panel (12a, 12b) which forms the expanded side outer wall, and each of the internal panels (20a, 20b) comprises floor panel (21a, 21b) which forms an expansion floor upon downward unfolding, and expansion side panel (22a and 23a, 22b and 23b) which forms the front and back expanded outer wall.

Variety of living facilities such as sink, bathroom, refrigerator, TV set, storage closet, sofa, and air conditioner are installed inside the upper main body (110). The upper main body (110) of the caravan (100) is suitable for loading onto small pick-up truck such as one-ton truck having for example, a width of 1,600 mm, a length of 2,500 mm, and height of 2,000 mm.

The lower main body carrier (120) is the portion that is loaded onto the one-ton truck, and is slightly smaller than the size of the upper main body (110), preferably has height of 500 mm. The lower main body carrier (120) houses various supporting equipments such as power generating unit, control unit, sink drain pipe, toilet and water tank. The lower main body carrier (120) also functions as storage for items such as varieties of tools.

All the panels in present invention are filled with insulation inside, and preferably utilizes aluminum sandwich panel assembled with aluminum panels on both sides.

Since the space-expandable caravan of present invention includes a structure in which both sides expand symmetrically, for convenience sake, description regarding one side is provided first.

With the external panel (10a) and the internal panel (20a) assembled, firstly the external panel (10a) is unfolded outward in order to spread out the roof panel (11a) and the expansion external panel (12a). The internal panel (20a) is then unfolded outward in order to spread out the floor panel (21a) and the expansion side panels (22a and 23a) of both sides. At this point the floor panel (21a) became horizontal with the bottom surface of the upper main body (110). The, legs (25) attached to bottom of the floor panel (21a) are unfolded. Two legs (25) are attached to of bottom of the floor panel (21a) at both corners.

The space-expandable caravan (100) of present invention can be set up by conveniently loading onto a cargo box of a truck by lifting the caravan using four jacks, and easily unloading from the cargo box to a desired place by again lifting the caravan using four jacks.

Since the space-expandable caravan of present invention can be transported by loading it on a truck, and can be towed by a towing vehicle by loading it on a trailer, smooth transporting process allows everyone to enjoy camping without limitation of location.

The present invention is now described in greater detail below, with reference to the appended drawings.

### Advantageous Effects of Invention

The present invention has advantageous effects of providing a space-expandable caravan that can expand a small living space of a caravan of approximately 4 m² up to about 12 m² which is about three-fold, and can be easily loaded, transported, unloaded, and set up by anyone by loading on to an one-ton pickup truck or a trailer and towing by a towing vehicle.

### BRIEF DESCRIPTION OF DRAWINGS

FIG. 1 depicts a schematic perspective view of a space-expandable caravan (100) according to an embodiment of present invention.

FIG. 2 depicts a schematic perspective view of the caravan (100) of FIG. 1 with the roof panel (11a) and the expansion external panel (12a) spread out by unfolding the external panel (10a).

FIG. 3 depicts a schematic perspective view of the floor panel (21a) spread out by unfolding the internal panel (20a) from the caravan (100) of FIG. 2, and with the expansion side panel (22a, 23a) not yet spread out.

FIG. 4 depicts a schematic perspective view of the expansion side panel (22a, 23a) spread out by unfolding the internal panel (20a) from the caravan (100) of FIG. 3.

FIG. 5 depicts a schematic perspective view of the caravan (100) of FIG. 1 with both left and right sides expanded and assembled.

FIG. 6 depicts a plan view of an embodiment of FIG. 5.

FIG. 7 depict schematic perspective views of legs (25) attached to bottom of the floor panel (21a), wherein 7A shows the legs (25) in folded position, and 7B shows the legs (25) in unfolded position.

FIG. 8 depict sectional views of the panels in assembled state, wherein 8A shows the floor panel (21a) and the expansion external panel (12a) assembled together, and 8B shows the expansion external panel (12a) and the expansion side panel (23a) assembled together.

FIG. 9 depicts a schematic perspective view of the roof panel (11a) and the expansion side panel (22a) held together by locking means (60), and the enlarged diagram is a perspective view of the locking means (60).

FIG. 10 depicts a schematic perspective view of the expansion side panel (23a) fixed to the inner wall of the upper main body by coupling means (70).

FIG. 11 depicts a schematic perspective view of an embodiment of the coupling means (70) of FIG. 10.

FIG. 12 depicts a schematic perspective view of a structure for lifting the caravan (100) of present invention using four jacks (50).

FIG. 13 depicts a schematic perspective view of a process of a truck (200) backing up and loading, after the caravan (100) of present invention have been lifted up by the jacks (50).

### DETAILED DESCRIPTION OF THE INVENTION WITH REFERENCE TO THE ACCOMPANYING DRAWINGS

The present invention relates to a caravan which is convenient to move, easy to set up, and is space-expandable.

The space-expandable caravan (100) of present invention comprises a cubical upper main body (110) housing various living facilities and a lower main body carrier (120) integrally formed on the lower portion of the upper main body.

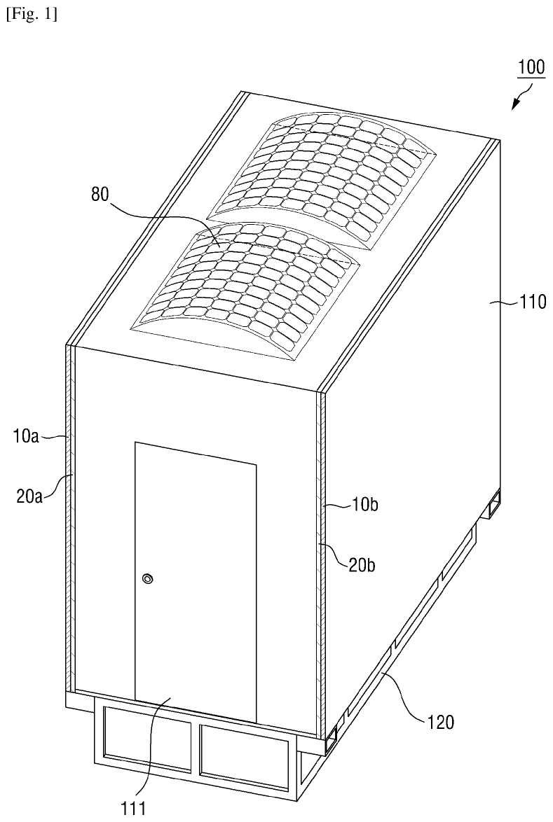

FIG. 1 is a schematic perspective view of the space-expandable caravan (100) according to an embodiment of present invention. Variety of living facilities such as sink, bathroom, refrigerator, TV set, storage closet, sofa, and air conditioner are installed inside the upper main body (110). A door (111) is appropriately installed on the upper main body (110) to allow entry inside. The lower main body carrier (120) which is integrally attached to the lower portion of the upper main body (110) is one of the features of present invention.

The dimension of the caravan (100) of present invention is selectively fixed to make it suitable for loading onto a one-ton truck. Preferably, the dimension, that is width×length×height of the upper main body (110) is fixed to 1,600 mm×2,500 mm×2,000 mm. In order to easily load and unload the caravan (100) onto and from the one-ton truck, the lower main body carrier (120) is made slightly smaller than the size of the upper main body (110). The height of the lower main body carrier (120) has to be slightly higher than the height of the cargo box of the truck, preferably it is fixed to 500 mm, to appropriately fit a cargo box of the one-ton truck. The dimension is not limited to this of course, and the upper main body can be manufactured in slightly bigger or smaller dimensions.

The lower main body carrier (120) houses various supporting equipments such as power generating unit, control unit, sink drain pipe, toilet and water tank. The lower main body (120) also functions as storage for items such as varieties of tools.

The space-expandable and easily transportable caravan of present invention includes a space expandable and collapsible panel unit in which both sides expand symmetrically. The upper main body (110) comprise a pair of larger dimensioned side walls thereof accommodating the space expandable and collapsible unit. The space expandable and collapsible panel unit comprises atleast one foldable external panels (10a, 10b) and atleast one foldable internal panels (20a, 20b) on each of side walls of the caravan. Therefore a description of a side wall of one side is sufficient to easily understand the whole structure.

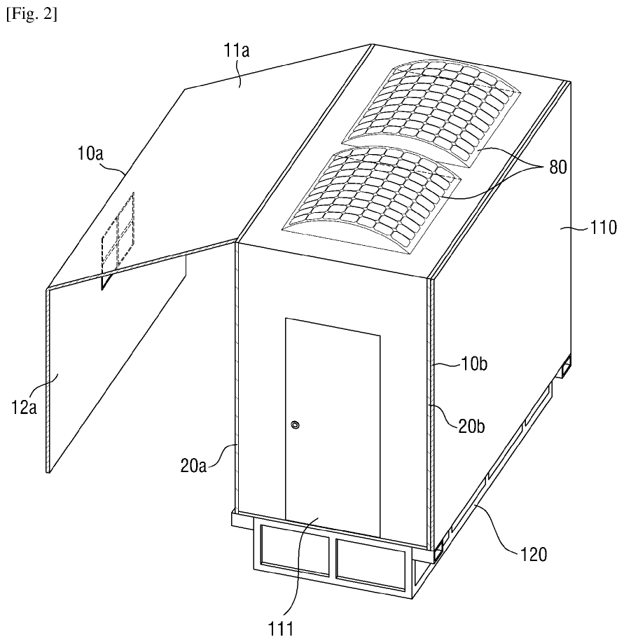

FIG. 2 is a schematic perspective view of the caravan (100) of FIG. 1 illustrating disposition of the roof panel (11a) and the expansion external panel (12a) spread out by unfolding the external panel (10a).

With the external panel (10a) and the internal panel (20a) assembled as shown in FIG. 1, firstly the external panel (10a) is unfolded outward in order to spread out the roof panel (11a) and the expansion external panel (12a). Reference in this context invited from FIG. 2 which is a schematic perspective view of the caravan (100) of FIG. 1 illustrating disposition of the spread out roof panel (11a) and the expansion external panel (12a) due to outward unfolding of the external panel (10a). The roof panel (11a) upon spread out forms an expanded roof of the caravan (100) while the expansion external panel (12a) upon spread out forms an expanded side outer wall of the caravan (100).

All the panels in present invention are filled with insulation inside, and preferably utilizes aluminum sandwich panel assembled with aluminum panels on both sides. Producing the roof panel (11a) and the expansion external panel (12a) in foldable structure can be easily performed by any skilled worker in the art.

The width of the roof panel (11a) is same as the height of the upper main body (110), and the height of the expansion external panel (12a) is slightly smaller than the height of the upper main body (110), such that the roof panel (11a) forms a slightly inclined plane after it is set up.

After outward unfolding of the external panel (10a), the internal panel (20a) is unfolded downward in order to spread the floor panels (21a) which form an expanded floor of the caravan (100), and to spread expansion side panels (22a and 23a) from both sides which form front (22a) and back (23a) expanded outer walls for assembling with the expanded side outer wall thus formed by the spread out of the expansion external panel (12a).

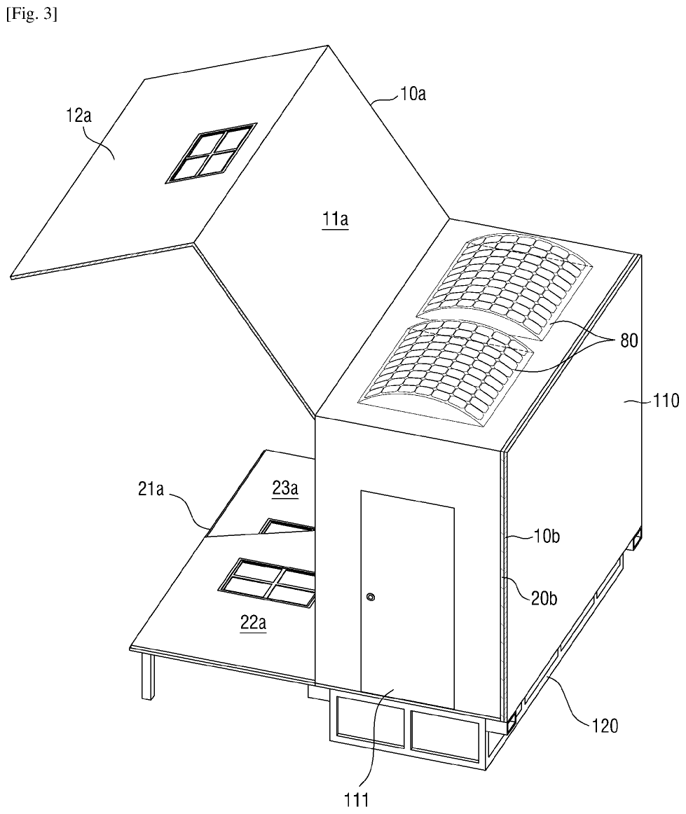

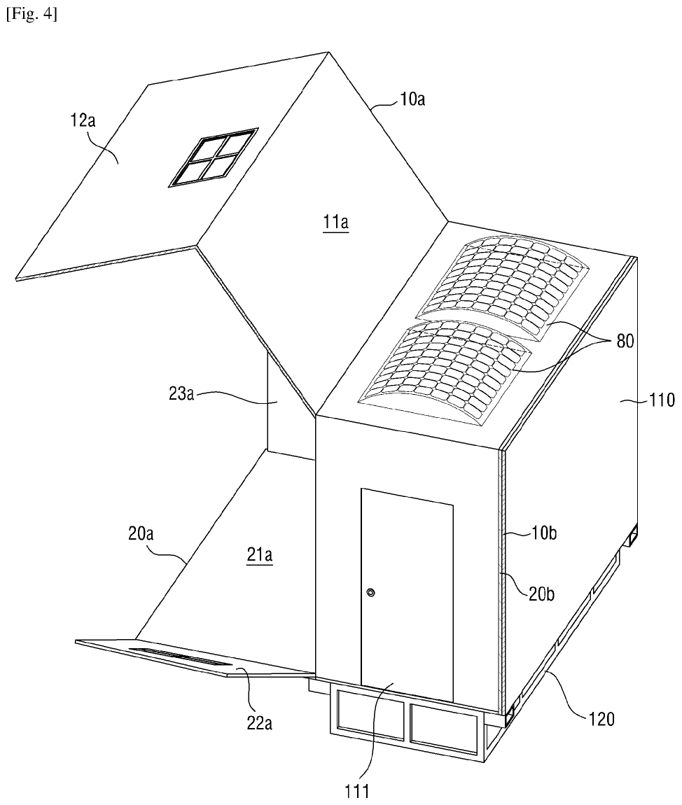

Reference in this context invited from FIG. 3 which is a schematic perspective view of the caravan (100) of FIG. 2 illustrating disposition of the spread out floor panel (21a) due to unfolding of the internal panel (20a). As shows in the FIG. 3, the expansion side panels (22a, 23a) are not yet spread out. The FIG. 4 shows the perspective view of the expansion side panel (22a, 23a) spread out by unfolding the internal panel (20a) from the caravan (100) of FIG. 3. The process of unfolding the external panel (10a) and the internal panel (20a) outward can be performed by exerting physical force, but also can be easily manipulated using remote controlled hydraulic system (not shown). Technical composition for such manipulation can be easily performed by any skilled worker in the art.

The external panel (10a) comprising the roof panel (11a) and the expansion external panel (12a), the structure of these panels spread out and folded, the internal panel (20a) comprising the floor panel (21a) and the expansion side panels (22a, 23a) of both sides, and the structure of these panels spread out and folded have not been described in detail, but these can be easily implemented by any skilled worker in the art.

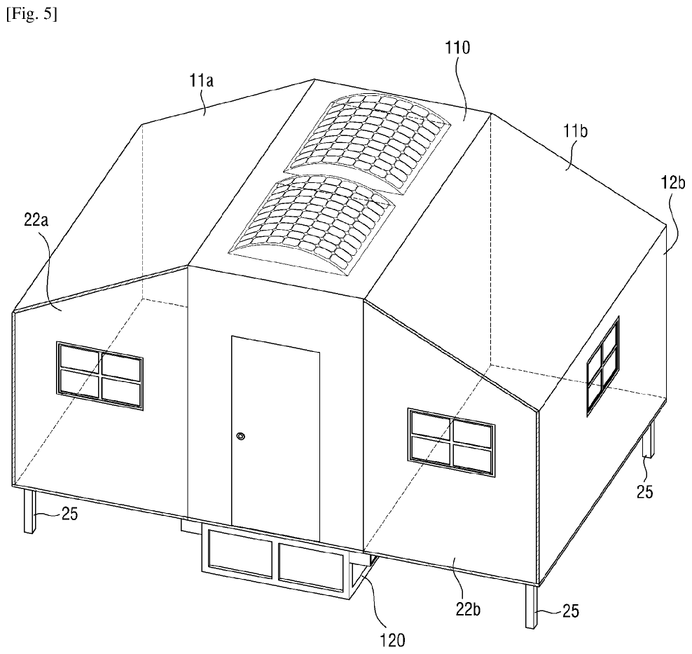

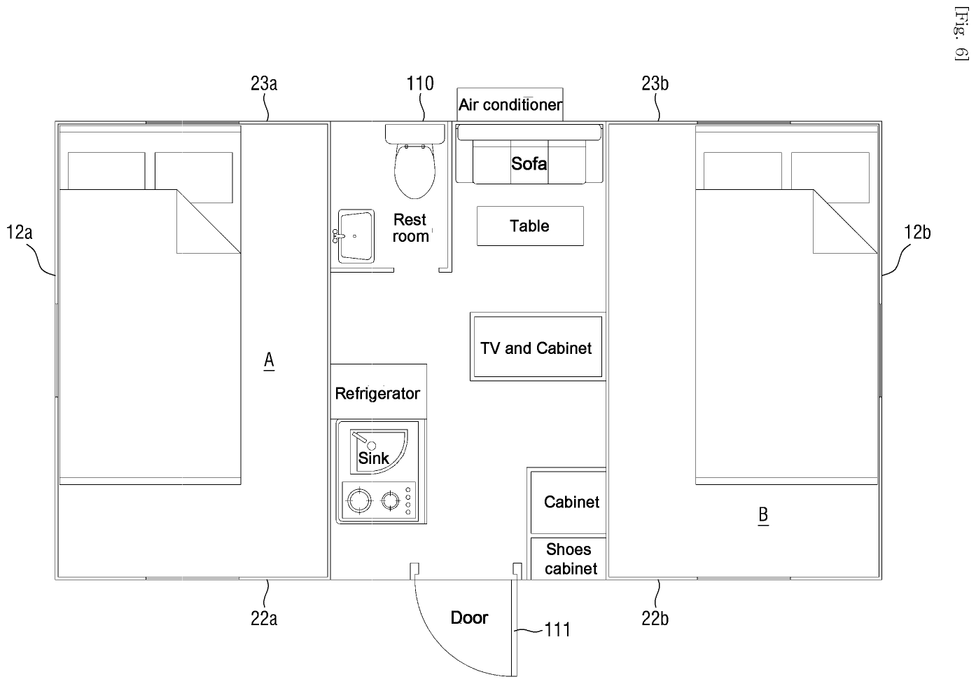

Reference is next invited from the accompanying FIG. 5 which is a schematic perspective view of the caravan (100) of FIG. 1 with both left and right sides expanded and assembled. The accompanying FIG. 6 shows iplan view of the embodiment of the FIG. 5.

As shown in FIG. 5 and FIG. 6, expanded space A is formed on the left and expanded space B is formed on the right, so that the entire expanded space corresponds to twice the space of the upper main body (110). If the area of the upper main body (110) is 4 m², the expanded area will be three times that, which is 12 m².

The floor panel (21a) should be horizontal with the bottom surface of the upper main body (110). Hence, in the present caravan (100) as shown in the FIG. 5, the floor panels (21a, 21b) are supported on four legs (25) which are attached to bottom of the floor panels (21a, 21b). Each of the floor panels (21a, 21b) accommodates two legs at its both bottom corners in folded configuration. As shown in FIG. 5, after spread out of the floor panels (21a, 21b), the legs are unfolded and supported on the ground to make the floor panels (21a, 21b) horizontal with the bottom surface of the upper main body (110).

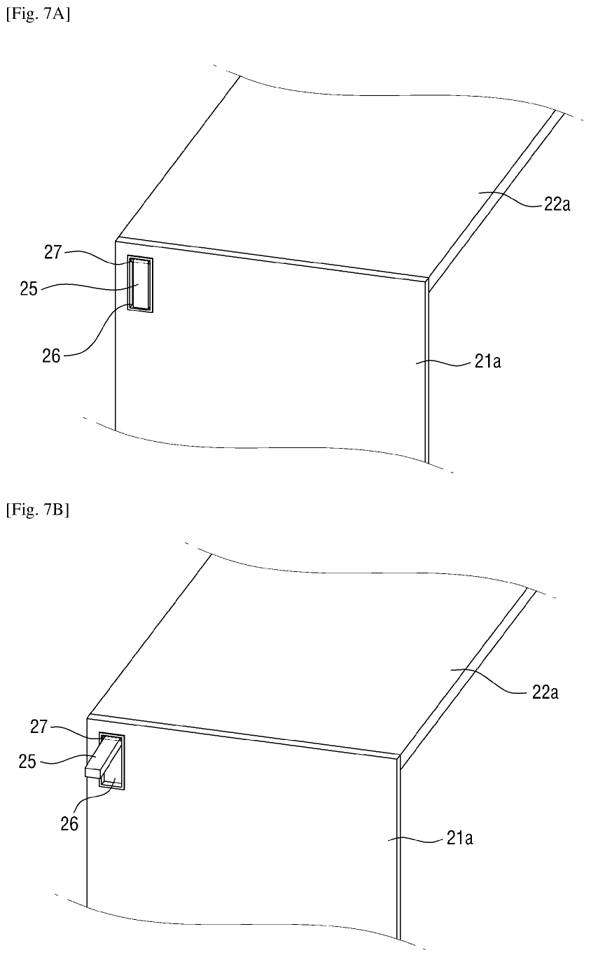

FIGS. 7A and 7B are schematic perspective views of the legs (25) attached to bottom of the floor panel (21a), wherein 7A shows the legs (25) in folded position, and 7B shows the legs (25) in unfolded position. The legs (25) are held in holding recesses (26) formed in the floor panel, and attached by fixing pin (27) to move in rotary motion of 90 degrees. When the legs (25) are unfolded by 90 degrees, locking means (not shown) are attached to prevent the legs from folding back easily.

The steps for assembling all the panels of present invention are as follows.

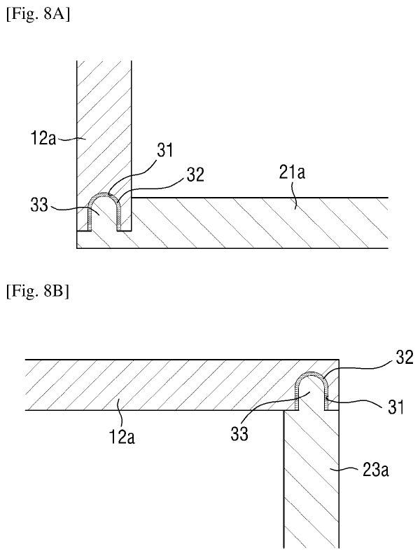

Firstly, two legs (25) are unfolded to keep the floor panel (21a) horizontal, and then the expansion external panel (12a) is inserted in the floor panel (21a) for assembly. FIGS. 8A and 8B are sectional views of the panels in assembled state, wherein 8A shows the floor panel (21a) and the expansion external panel (12a) assembled together. As shown, an engaging protrusion (33) is formed on the floor panel (21a), and a groove (31) is formed on the expansion external panel (12a), such that these panels are interlocked with each other when the engaging protrusion (33) sits within the groove (31). Because this interlocked joint should be sealed considering soundproofing, air conditioning and heating requirement in the caravan and such, elastic rubber material (32) is inserted in the groove (31) for this purpose.

FIG. 8B is a sectional view of the expansion external panel (12a) and the expansion side panel (23a) assembled together.

After the floor panel (21a) and the expansion external panel (12a) are assembled together, the expansion side panels (22a, 23a) of both sides are assembled on the expansion external panel (12a) one after the other. An engaging protrusion (33) is formed on the expansion side panels (22a, 23a), and a corresponding groove (31) is formed on the expansion external panel (12a), such that these panels are interlocked with each other when the engaging protrusion (33) sits within the groove (31). Elastic rubber material (32) is also inserted in the groove (31) for complete seal up.

The expansion side panels (22a, 23a) are joined with the floor panel (21a) by spring hinges (not shown). Due to the spring hinges, the expansion side panels (22a, 23a) can move freely about 10 cm from left to right. As a result, anyone can connect the expansion side panels (22a, 23a) to the floor panel (21a) without difficulty.

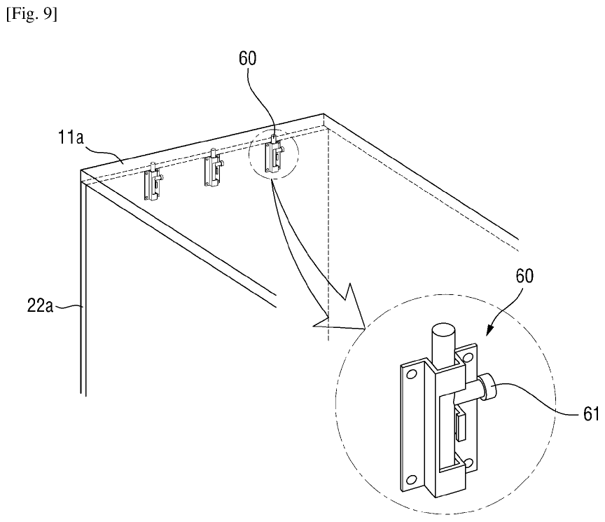

The expansion side panels (22a and 23a) and the roof panel (11a) are fixed by plurality of locking means (60). FIG. 9 is a schematic perspective view of the roof panel (11a) and the expansion side panel (22a) held together by locking means (60), and the enlarged diagram is a perspective view of the locking means (60). Although three locking means (60) are shown on FIG. 9, it is not limited to this specific number, and different modified locking means other than those shown on FIG. 9 can be easily used by skilled workers in the art. For complete seal up between the expansion side panels (22a and 23a) and the roof panel (11a), elastic sealing material such as high strength sponge (not shown) can be additionally attached to the part where these panels contact each other.

Lastly, the expansion side panels (22a and 23a) are firmly attached to the inner wall of the upper main body (110) by plurality of coupling means (70).

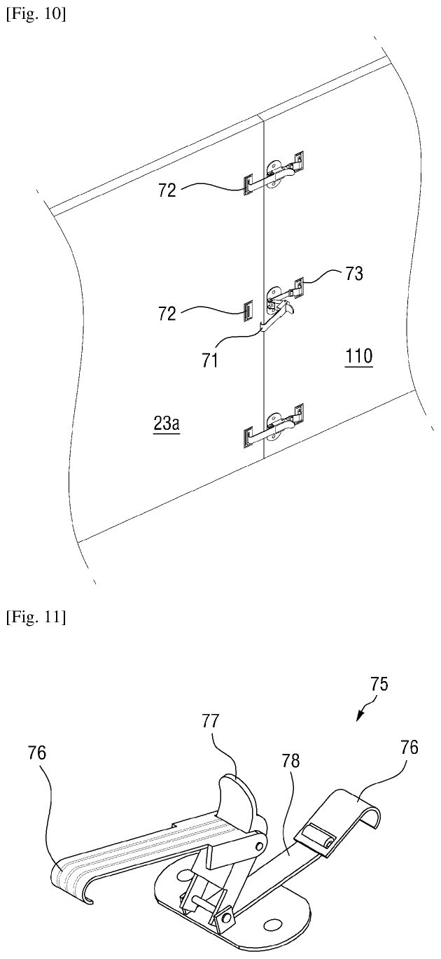

FIG. 10 is a schematic perspective view of the expansion side panel (23a) fixed to the inner wall of the upper main body by coupling means (70).

As shown on FIG. 10, the coupling means (70) are attached on inner wall of the upper main body (110), and the attached coupling means (70) are consisted of a structure in which a hook (71) can be moved by a handle (73). The upper main body (110) and the expansion side panel (23a) are firmly held together by moving the handle (73), latching the hook (71) into a catch (72) formed to hold the hook (71) on the expansion side panel (23a), and pressing down the handle (73). Although three coupling means (70) are shown on FIG. 10, it is not limited to this specific number.

FIG. 11 depicts a ratchet-strap assembly (75) which is another coupling means for holding the upper main body (110) together with the expansion side panel (23a). This assembly (75) is consisted of a strap (78), a handle (77), and two hooks (76), wherein each of the hooks (76) are latched on to catch formed on the upper main body (110) and the expansion side panel (23a), and then the handle (77) is pressed down to hold the panels together. This assembly (75) and other forms of coupling means (70) can be easily used by skilled workers in the art.

The caravan (100) of present invention can be set up by lifting up the caravan up with four jacks and then conveniently loading it onto a cargo box of a truck, and by easily unloading it from the cargo box to desired location.

Even though present invention have been described mainly focusing on the external panel (10a) and the internal panel (20a) on left side, since the left and right side walls form symmetrical structure, the external panel (10b) and the internal panel (20b) on the right side can be understood the same way.

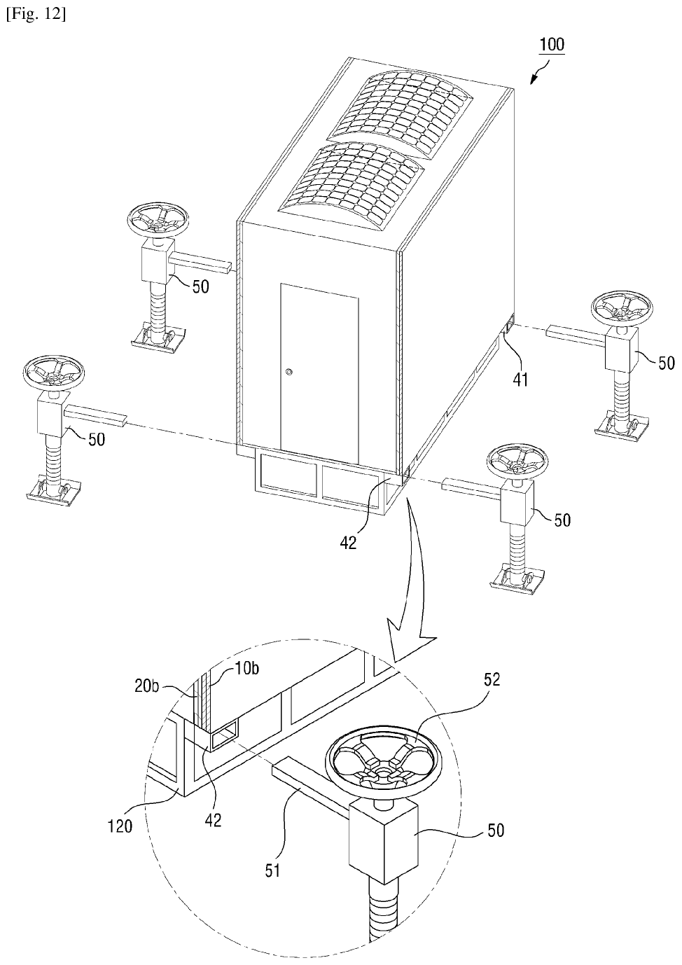

FIG. 12 is a schematic perspective view of a structure for lifting up the caravan (100) of present invention using four jacks (50). Two rectangular pipes (41, 42) are built in transversely at the two corners, front and back, where the upper main body (110) and the lower main body (120) are integrally attached, such that they works as frames while allowing the rectangular member (51) of the jack (50) to be inserted. The caravan (100) is lifted up by inserting rectangular members (51) of the jacks (50) into these rectangular pipes (41, 42), and then rotating a handle (52).

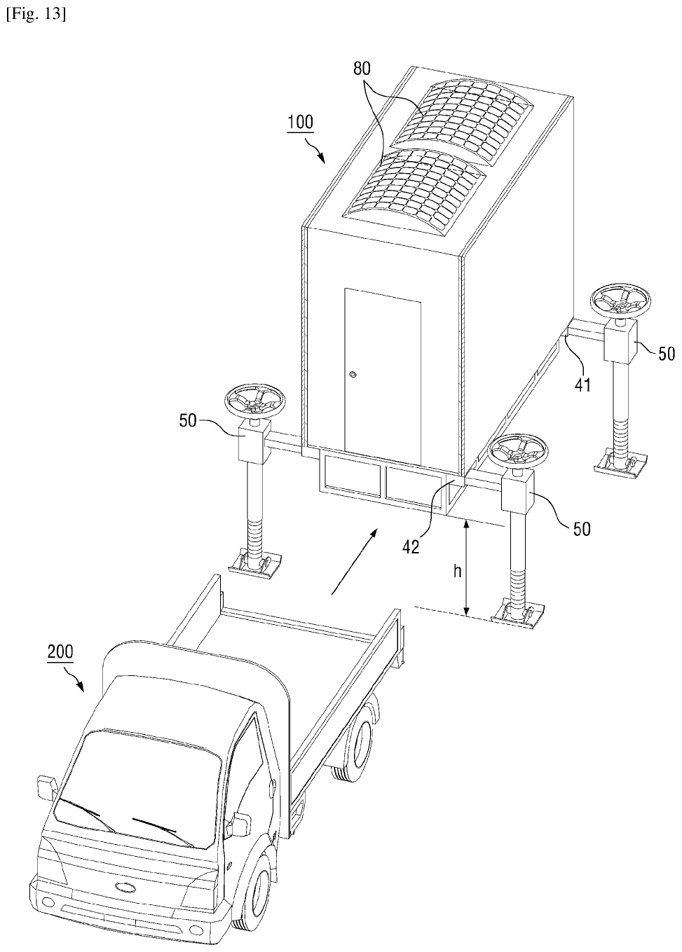

FIG. 13 is a schematic perspective view of a process of a truck (200) backing up and loading, after the caravan (100) of present invention have been lifted up by the jacks (50). Once the caravan (100) has been lifted up sufficiently, the truck is backed up to move the cargo box under the lifted caravan (100). The caravan (100) is loaded onto the cargo box of the truck by unfastening four jacks (50) in place, and then all the jacks (50) are removed.

Solar panels (80) can be appropriately installed on top of the caravan (100) of present invention to produce needed electricity. Air conditioning and heating system, sink, bathroom, as well as power generating unit and such can be easily implemented by skilled workers in the art as those installed in conventional caravans or camping cars. For example, the caravan can be heated by installing heating wire or pipes, for hot water to flow through, inside the floor panels (21a, 21b). Air conditioning system can be installed, not only in the upper main body (110), but also in the expanded space (A, B) by extension.

By using four jacks (50), the user of the caravan can easily lift the caravan (100) of present invention, load the lifted caravan onto a truck or a trailer, and unload the caravan from the truck or the trailer to set up. Further, the user does not require separate license for transporting the caravan.

The space-expandable caravan of present invention can be transported by loading it on a truck, and can be towed by a towing vehicle by loading it on a trailer, therefore facilitating smooth transporting process that allows everyone to enjoy camping without limitation of location.

The present invention may be put into practice with simple modifications and variations by persons skilled in the art, and such modifications and variation are all within the scope of the present invention.

1. A space-expandable and easily transportable caravan characterized in that, the caravan comprises:
a cubical upper main body having space expandable and collapsible panel unit and a lower main body carrier integrally attached thereunder supporting the upper main body;
said space expandable and collapsible panel unit is expandable from sides comprising atleast one foldable external panels and atleast one foldable internal panels on each of side walls of the caravan,
wherein each external panel comprises roof panel to forms an expansion roof upon its outward unfold, and expansion external panel to form an expanded side outer wall, and each internal panel comprises floor panel to form an expansion floor upon its downward unfold, and expansion side panel to form front and back expanded outer wall.

2. The space-expandable and easily transportable caravan of claim 1, wherein the upper main body comprise a pair of larger dimensioned side walls thereof accommodating said space expandable and collapsible unit.

3. The space-expandable and easily transportable caravan of claim 1 comprising
said cubical upper main body housing various living facilities installed within;
each of larger dimensioned side walls of the caravan main body accommodating respective expandable and collapsible units including external panels and internal panels,
wherein each external panel comprises roof panel which forms the expansion roof by unfolding it outwards, and expansion external panel which forms the expanded side outer wall, and each internal panel comprises floor panel which forms the expansion floor by unfolding it downwards, and expansion side panel which forms the front and back expanded outer wall.

4. The space-expandable and easily transportable caravan of claim 1, wherein the caravan is suitable for loading onto a one-ton truck, wherein the lower main body carrier is slightly smaller than the size of the upper main body as it is the portion that is loaded onto a cargo box of the one-ton truck, and has a height slightly higher than height of the cargo box of the truck to appropriately fit the cargo box of the one-ton truck.

5. The space-expandable and easily transportable caravan of claim 3, wherein width×length×height of the upper main body is 1,600 mm×2,500 mm×2,000 mm.

6. The space-expandable and easily transportable caravan of claim 1, wherein the roof panels, the expansion external panels, the floor panels, and the expansion side panels are filled with insulation inside, and involves aluminum sandwich panel assembled with aluminum panels on both sides.

7. The space-expandable and easily transportable caravan of claim 1, wherein the floor panel comprises two foldable legs attached to bottom of the floor panel at both corners.

8. The space-expandable and easily transportable caravan of claim 1, wherein the caravan further comprises hydraulic system and a remote control, such that a process of unfolding the external panels and the internal panels outward can be carried out automatically.

9. The space-expandable and easily transportable caravan of claim 1, wherein the floor panels are inserted into the expansion external panels for assembly, and an engaging protrusion is formed on the floor panels, and a groove is formed on the expansion external panels whereby the engaging protrusion is configured to sits within the groove for the assembly.

10. The space-expandable and easily transportable caravan of claim 9, wherein the expansion external panels are inserted into the expansion side panels of both sides for assembly, and an engaging protrusion is formed on the expansion side panels, and a groove is formed on the expansion external panels whereby the engaging protrusion is configured to sits within the groove for the assembly.

11. The space-expandable and easily transportable caravan of claim 10, wherein the expansion side panels are joined with the floor panels by spring hinges.

12. The space-expandable and easily transportable caravan of claim 11, wherein the expansion side panels and the roof panels are held together by plurality of locking means.

13. The space-expandable and easily transportable caravan of claim 12, wherein the expansion side panels are fixed firmly to the inner wall of the upper main body by plurality of coupling means.

14. The space-expandable and easily transportable caravan of claim 1, wherein the caravan further comprises solar panels installed on top of the upper main body.

15. The space-expandable and easily transportable caravan of claim 1, wherein the caravan further comprises two rectangular pipes which are transversely built at two corners, front and back, where the upper main body (110) and the lower main body are integrally attached to work as frames while allowing rectangular members of jacks to be inserted into each of the rectangular pipes for lifting the caravan.

16. The space-expandable and easily transportable caravan of claim 15, wherein the caravan is transported by loading the caravan onto a truck, or towed by a towing vehicle by loading the caravan onto a trailer.

17. The space-expandable and easily transportable caravan of claim 16, wherein the towing vehicle is a passenger car.
